(19) United States
(12) Patent Application Publication
(10) Pub. No.: US 2012/0230432 A1
(43) Pub. Date: Sep. 13, 2012

(54) SIGNALING NUMBER OF ACTIVE LAYERS IN VIDEO CODING

(76) Inventors: Jill Boyce, Manalapan, NJ (US); Danny Hong, New York, NY (US)

(21) Appl. No.: 13/414,908

(22) Filed: Mar. 8, 2012

Related U.S. Application Data
(60) Provisional application No. 61/451,462, filed on Mar. 10, 2011.

(51) Int. Cl. H04N 7/26; G06F 15/16

(52) U.S. Cl. 375/240.25; 709/231; 375/E07.027

(57) ABSTRACT

The representation of information related to the number of active enhancement layers in a scalable bitstream in data structures that are sent synchronous with coded pictures or slices is disclosed herein. Systems and methods for video coding include receiving and decoding an Active Number of Layers message.

### PRIORITY CLAIM

This application claims priority to U.S. Provisional Application Ser. No. 61/451,462 titled “Signaling Number of Active Layers in Video Coding,” filed Mar. 10, 2011, the disclosure of which is hereby incorporated by reference in its entirety.

### FIELD

The present application relates to video coding, and more specifically, to the representation of information related to the number of active enhancement layers in a scalable bitstream in data structures that are sent with coded pictures or slices.

### BACKGROUND

Scalable video coding refers to techniques where a base layer can be augmented by one or more enhancement layers. When base and enhancement layer(s) are reconstructed jointly, the reproduced video quality can be higher than if the base layer is reconstructed in isolation.

In scalable video coding, many forms of enhancement layer types have been reported, including temporal enhancement layers (that increase the frame rate), spatial enhancement layers (that increase the spatial resolution), and SNR enhancement layers (that increase the fidelity, that can be measured in a Signal to Noise SNR ratio).

Referring to FIG. 1, in scalable video coding, the relationship of layers can be depicted in the form of a directed graph. In the example presented, a base layer (101) (that can be, for example, be in CIF format at 15 fps) can be augmented by a temporal enhancement layer (102) (that can, for example increase the frame rate to 30 fps). Also available can be a spatial enhancement layer (103) that increases the spatial resolution from CIF to 4CIF. Based on this spatial enhancement layer (103), another temporal enhancement layer can increase the frame rate to 30 fps.

In order to reconstruct a 4CIF, 30 fps signal, all base layer (101), spatial enhancement layer (103), and second temporal enhancement layer (104) should be present. Other combinations are also possible, as indicated in the graph.

Layering structure information can be useful in conjunction with network elements that remove certain layers in response to network conditions. Referring to FIG. 2, shown is a sending endpoint (201), which sends a scalable video stream (that may have a structure as described before) to an application layer router (202). The application layer router can omit forwarding certain layers to endpoints (203), (204), based on its knowledge of the endpoints' capabilities, network conditions, and so on. U.S. Pat. No. 7,593,032 incorporated herein by reference in its entirety describes exemplary techniques that can be used for the router.

The layered video can be coded according to ITU-T Rec. H.264. “Advanced video coding for generic audiovisual services”, March 2010, available from the International Telecommunication Union (“ITU”), Place de Nations, CH-1211 Geneva 20, Switzerland or http://www.itu.int/rec/T-REC-H.264, and incorporated herein by reference in its entirety, and, more specifically, to H.264's scalable video coding (SVC) extension, or to other video coding technology supporting scalability, such as, for example, the forthcoming scalable extensions to “High Efficiency Video Coding” (hereinafter “HEVC”), which is at the time of writing in the process of being standardized.

According to H.264, the bits representing each layer are encapsulated in one or more Network Adaptation Layer units (NAL units). Each NAL unit can contain a header that can indicate the layer the NAL unit belongs to.

However, without observing multiple NAL units belonging to all the layers, analyzing their content, and, thereby, building a “picture” of the layers available, a router can lack a mechanism to derive the layering structure as described above. Without knowledge of the layering structure, a router may not make sensible choices for removing NAL units belonging to certain layers.

When a layering structure is used, the layering structure should be known before the first bit containing video information arrives at the router. The RTP payload format for SVC, (Wenger, Wang, Schierl, Eleftheriadis, “RTP Payload Format for Scalable Video Coding”, RFC 6190, available from http://tools.ietf.org/html/rfc6190), incorporated herein by reference in its entirety, includes a mechanism to integrate the content of the scalability information SEI message containing the layering structure in the capability exchange messages, for example using the Session Initiation Protocol (Rosenberg et. al., “SIP: Session Initiation Protocol” RFC 3261, available from http://tools.ietf.org/html/rfc3261) and incorporated herein by reference in its entirety). However, decoding this SEI message generally requires bit oriented processing of video syntax, something a router is not often prepared to do efficiently. The SEI message is also complex and can be of significant size—its syntax specification spans three pages in H.264.

Disclosed in co-pending U.S. patent application, “Dependency Parameter Set for Scalable Video Coding,” Ser. No. 13/414,075, filed Mar. 7, 2012, incorporated herein by reference in its entirety, are, amongst other things, techniques to code and decode information related to a layering structure in a Dependency Parameter Set (DPS). Specifically, the dependencies between a base layer, one or more spatial enhancement layers, and/or one or more SNR enhancement layers can be efficiently represented.

The DPS can solve many problems in announcing the layering structure between the various sending and receiving entities (such as routers and endpoints) in a scenario such as the one of FIG. 2. However, a DPS, like any parameter set, is static in nature, and its occurrence in the bitstream is not necessarily synchronized with pictures or slices in the bitstream, making its use typically inadvisable to announce dynamic layering changes—specifically the removal of one or more layers from the full layering structure that can be described in the DPS—a router may have introduced in response to changes in the environment, for example change in the network conditions.

The receiving endpoints (203), (204) should receive accurate, timely information about the layering structure they are about to receive and, in order to achieve the best user experience possible, required to decode. With such information available, an endpoint can, for example, conserve resources (i.e. reduce CPU clock rate and thereby preserve battery power) when it is known that certain layers are not going to be available for decoding. A decoding device can also adjust other parameters reflecting the unavailability of layers. For example, if it is known that certain layers are not being received, the expected packet reception rate can be lower compared to when expecting all layers to be received, which can allow for the adjusting in size of jitter buffers and similar data structures.

In the context of HVEC, the high level syntax mechanism for the transmission of information that can a) change dynamically between pictures or even slices, that b) needs to be conveyed synchronously with pictures or slices, and that c) is not required for the decoding process, is an SEI message. HVEC's high level syntax is derived from the high level syntax of ITU-T Rec. H.264 by agreement of the committee standardizing HVEC, and because in H.264, SEI messages are the data structure to support requirements a), b), and c) above.

The syntax of SEI messages is defined such that, in a container format specified identically for all SEI messages, SEI message “content” can be included. The creation of the SEI message container format requires only minimal bit oriented processing. The creation of content, however, can be complex, depending on the nature of the content. The syntax definition of the Scalability Information SEI message of H.264, for example, spans no less than three pages in the compact form of syntax diagram used in H.264. Many of the parameters therein require bit-oriented processing and/or are variable length codes. A router, whose processing elements (CPU etc.) may not be optimized to efficiently handle those many dozens of bit oriented parameters cannot efficiently generate those SEI message for every change in network conditions on every link to its connected endpoints.

Accordingly, there exists a need for a simplified message format both the router (which may need to generate, or modify, the message) and for the endpoint (which needs to decode it).

### SUMMARY

The disclosed subject matter, in one embodiment, provides for an Active Number of Layers message (ANL) that can include fixed length codewords so to enable efficient generation in network elements such as routers.

In the same or another embodiment, the Active Number of Layers message is in the format of an Active Number of Layers SEI message (ANL-SEI).

In the same or another embodiment, the Active Number of Layers message is part of a high level syntax structure sent synchronously with in bitstream such as picture header, slice header, Access Unit Delimiter, and so forth.

In the same or another embodiment, the scalable bitstream including the ANL can be created or modified by a router and sent from a router to another router or to an endpoint in response to the removal of layers of the scalable bitstream in the router.

In the same or another embodiment, the content of the ANL can be composed of fixed length codewords.

In the same or another embodiment, the ANL can include an integer indicative of the number of active spatial enhancement layers.

In the same or another embodiment, the ANL can include an integer indicative of the number of active SNR enhancement layers.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a layering structure of a layered bitstream in accordance with Prior Art;

FIG. 2 is a schematic illustration of a system using layered video coding;

FIG. 3 is a schematic illustration of a video bitstream in accordance with an exemplary embodiment of the present invention;

FIG. 4 is a schematic illustration of exemplary representations of orientation information in accordance with an exemplary embodiment of the present invention;

FIG. 5 is a timing diagram showing an exemplary relationship in time between the sending of a Dependency Parameter Set, base layer, enhancement layer, and Active Number of Layer SEI message; and

FIG. 6 is a computer system in accordance with an exemplary embodiment of the present invention.

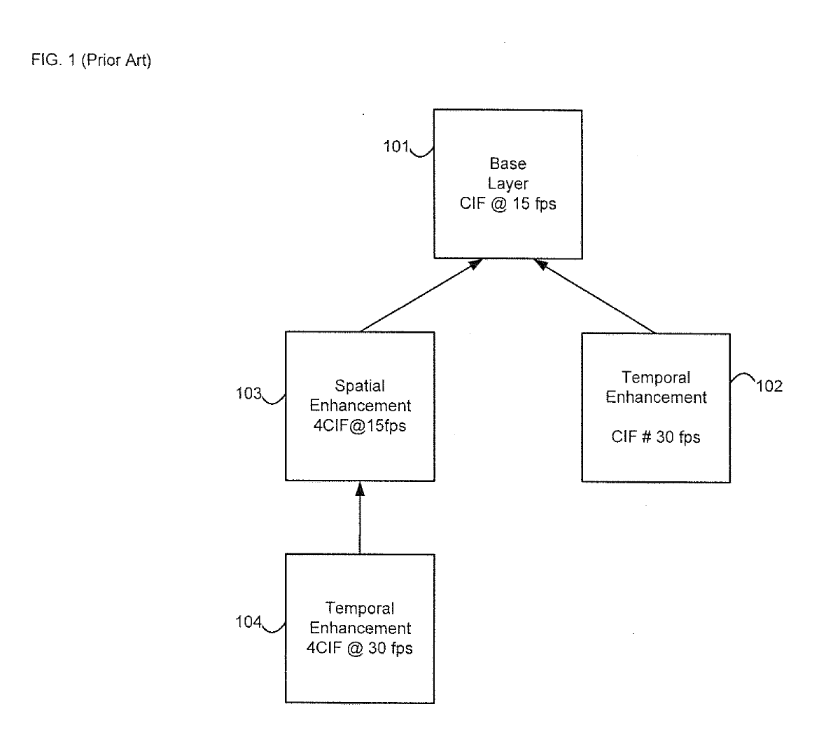

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

The present disclosure provides video coding techniques which include creating, sending, receiving and decoding an Active Number of Layers (ANL) message. Exemplary techniques utilize a representation of information related to the number of layers in a scalable bitstream structures that are sent synchronous with coded pictures or slices.

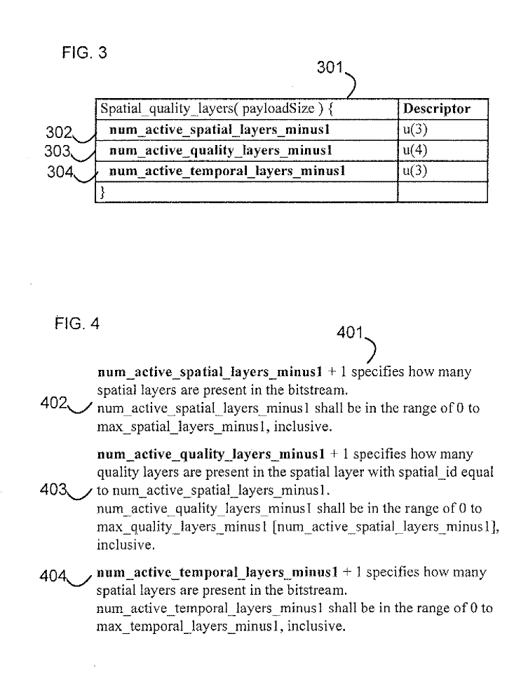

FIG. 3 shows a syntax diagram, following the conventions described in ITU-T Rec. H.264, of an Active Number of Layers message (ANL) (301) in accordance with an exemplary embodiment of the invention.

FIG. 4 shows a semantics definition, following the conventions described in ITU-T Rec. H.264, of an ANL (401) in accordance with an exemplary embodiment of the invention.

In the same or another embodiment, the ANL can include an integer indicating the number of active spatial layers (num_active_spatial_layers_minus1+1) (302) (402), which can specify how many spatial layers are present in the bitstream. num_active_spatial_layers_minus1 can be in the range of 0 to max_spatial_layers_minus1, inclusive.

In the same or another embodiment, the ANL can include an integer indicating the number of active quality layers (num_active_quality_layers_minus1+1) (303) (403), which can specify how many quality layers are present in the spatial layer with spatial_id equal to num_active_spatial_layers_minus1. num_active_quality_layers_minus1 can be in the range of 0 to max_quality_layers_minus1 [num_active_spatial_layers_minus1], inclusive.

In the same or another embodiment, the ANL can include an integer indicating the number of active temporal layers (num_active_temporal_layers_minus1+1) (304) (404), which can specify the number of active temporal layers present in the bitstream.

In the same or another embodiment, the content of an ANL can be an SEI message, or a part of another SEI message, for example another SEI message describing the properties of a layer or layer category (for example temporal, spatial, SNR) in more detail.

In the same or another embodiment, the ANL can be part of a NAL unit carrying high level syntax structures synchronously with the bitstream, such as a slice header, picture header, NAL unit header, Access Unit Delimiter, and so forth.

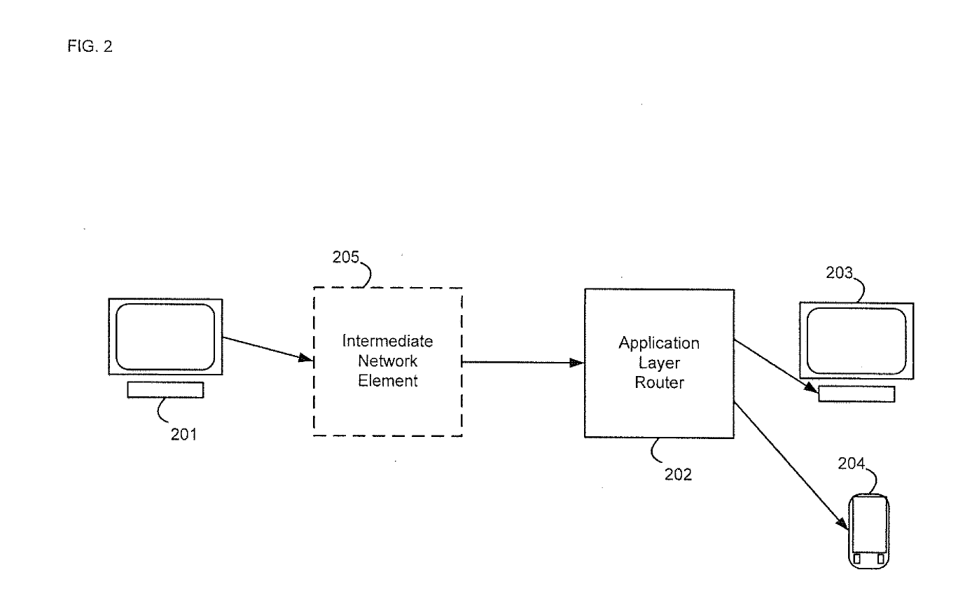

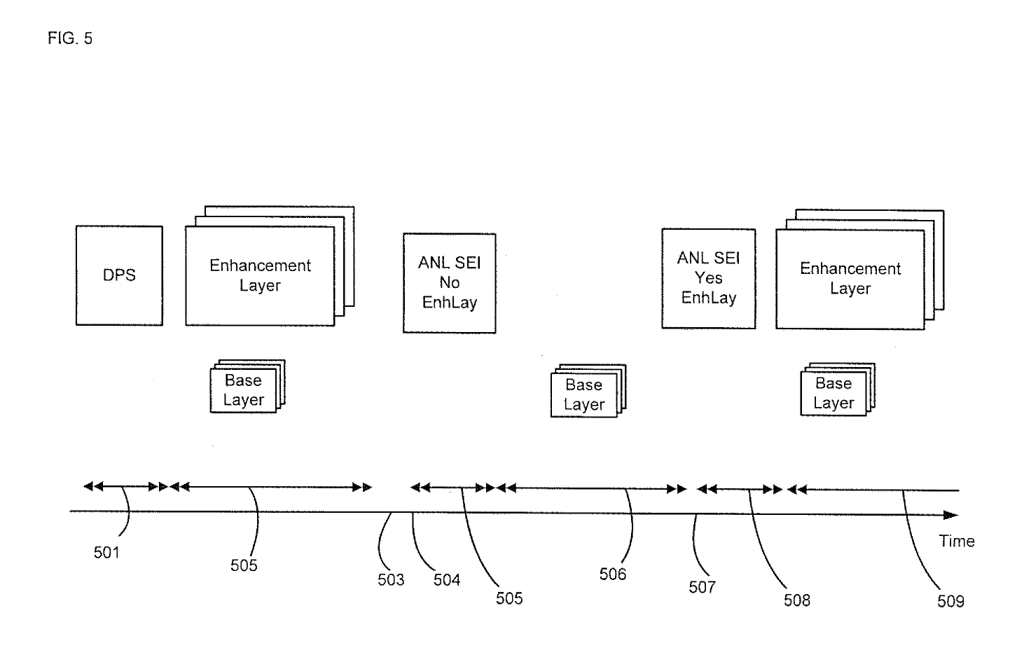

Referring to FIG. 2 and FIG. 5, shown, as one application for the ANL, is a timeline and data relative to this timeline that is output by router (202) and sent to endpoint (203). On an exemplary embodiment, Endpoint (203) includes the screen/display window size resources, computational resources, and network connectivity, to support a base layer and, in this example, one spatial enhancement layer. However, the network conditions between router (202) and endpoint (203) are assumed highly variable, and at times allow for the transmission of the enhancement layer, whereas at other times do not allow for that.

The DPS is transmitted early (501) in the session, and includes, in this example and based on the conditions stated above, information indicating the potential presence of base and enhancement layer.

At a time interval of good network conditions (502), both base and enhancement layers are sent.

At point in time (503), the network conditions deteriorate to a point where the sending of the enhancement layer becomes impossible (too many losses on the link between router (202) and endpoint (203)). Router (202) can learn about these losses, for example through the RTCP receiver reports sent by endpoint (203).

At point in time (504), shortly after router (202) has learned about the deteriorating network conditions, router (202) decides to stop sending the enhancement layer. In order to inform endpoint (203) about this decision, router (202) sends (505) an ANL indicating the absence of the enhancement layer. In the time interval of poor network conditions (506), router (202) sends only the base layer, but occasionally probes for better network conditions. At point in time (507), router (202) learns that the network conditions have improved to allow sending of the enhancement layer again. Accordingly, at point in time (508), router (202) sends an ALN indicating the presence of the enhancement layer. Endpoint (203), upon reception of the ALN, can allocate resources, change screen layout, or perform other activities in time, before router (202) commences again to send the enhancement layer at point in time (509).

It will be understood that in accordance with the disclosed subject matter, the bit rate fluctuation control techniques described herein can be implemented using any suitable combination of hardware and software. The software (i.e., instructions) for implementing and operating the aforementioned rate estimation and control techniques can be provided on computer-readable media, which can include, without limitation, firmware, memory, storage devices, microcontrollers, microprocessors, integrated circuits, ASICs, on-line downloadable media, and other available media.

### Computer System

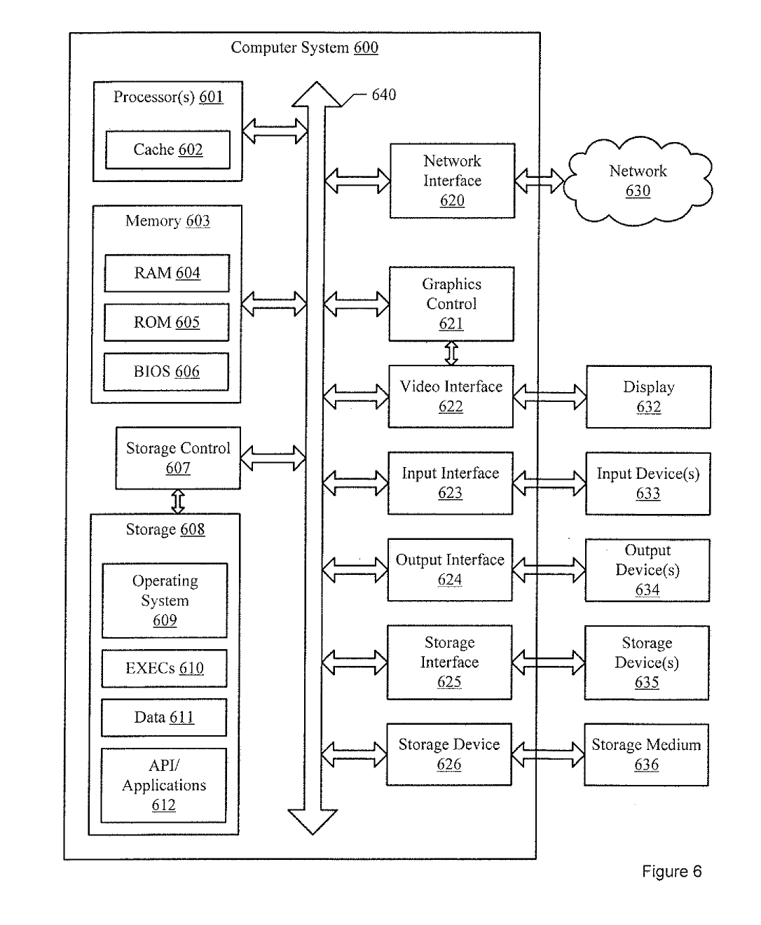

The methods described above can be implemented as computer software using computer-readable instructions and physically stored in computer-readable medium. The computer software can be encoded using any suitable computer languages. The software instructions can be executed on various types of computers. For example, FIG. 6 illustrates a computer system 600 suitable for implementing embodiments of the present disclosure.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 600 can have many physical forms including an integrated circuit, a printed circuit board, a small handheld device (such as a mobile telephone or PDA), a personal computer or a super computer.

Computer system 600 includes a display 632, one or more input devices 633 (e.g., keypad, keyboard, mouse, stylus, etc.), one or more output devices 634 (e.g., speaker), one or more storage devices 635, various types of storage medium 636.

The system bus 640 link a wide variety of subsystems. As understood by those skilled in the art, a “bus” refers to a plurality of digital signal lines serving a common function. The system bus 640 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 601 (also referred to as central processing units, or CPUs) optionally contain a cache memory unit 602 for temporary local storage of instructions, data, or computer addresses. Processor(s) 601 are coupled to storage devices including memory 603. Memory 603 includes random access memory (RAM) 604 and read-only memory (ROM) 605. As is well known in the art, ROM 605 acts to transfer data and instructions uni-directionally to the processor(s) 601, and RAM 604 is used typically to transfer data and instructions in a bi-directional manner. Both of these types of memories can include any suitable of the computer-readable media described below.

A fixed storage 608 is also coupled bi-directionally to the processor(s) 601, optionally via a storage control unit 607. It provides additional data storage capacity and can also include any of the computer-readable media described below. Storage 608 can be used to store operating system 609, EXECs 610, application programs 612, data 611 and the like and is typically a secondary storage medium (such as a hard disk) that is slower than primary storage. It should be appreciated that the information retained within storage 608, can, in appropriate cases, be incorporated in standard fashion as virtual memory in memory 603.

Processor(s) 601 is also coupled to a variety of interfaces such as graphics control 621, video interface 622, input interface 623, output interface, storage interface, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 601 can be coupled to another computer or telecommunications network 630 using network interface 620. With such a network interface 620, it is contemplated that the CPU 601 might receive information from the network 630, or might output information to the network in the course of performing the above-described method. Furthermore, method embodiments of the present disclosure can execute solely upon CPU 601 or can execute over a network 630 such as the Internet in conjunction with a remote CPU 601 that shares a portion of the processing.

According to various embodiments, when in a network environment, i.e., when computer system 600 is connected to network 630, computer system 600 can communicate with other devices that are also connected to network 630. Communications can be sent to and from computer system 600 via network interface 620. For example, incoming communications, such as a request or a response from another device, in the form of one or more packets, can be received from network 630 at network interface 620 and stored in selected sections in memory 603 for processing. Outgoing communications, such as a request or a response to another device, again in the form of one or more packets, can also be stored in selected sections in memory 603 and sent out to network 630 at network interface 620. Processor(s) 601 can access these communication packets stored in memory 603 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 600 can provide functionality as a result of processor(s) 601 executing software embodied in one or more tangible, computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface. The software can cause processor(s) 601 to execute particular processes or particular parts of particular processes described herein, including defining data structures stored in memory 603 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It should also be noted that there are many alternative ways of implementing the methods and apparatuses of the disclosed subject matter.

We claim:

1. A method for video decoding, comprising:
at at least one of a decoder and a router, receiving and decoding at least one Active Number of Layers (ANL) message.

2. The method of claim 1, wherein the ANL message includes two or more fixed length codewords.

3. The method of claim 2, wherein at least one of the fixed length codewords represents a layer.

4. The method of claim 2, wherein at least one of the fixed length codewords represents a number of layers of a category.

5. The method of claim 4, wherein the category is selected from the group consisting of a spatial layer category, a quality layer category, and a temporal layer category.

6. The method of claim 1, wherein the ANL message is included in an SEI message.

7. The method of claim 1, wherein the ANL message comprises an SEI message.

8. The method of claim 1, wherein the ANL message is included in an Access Unit Delimiter.

9. The method of claim 1, wherein the ANL message is included in a high level syntax structure.

10. The method of claim 1, wherein the ANL message includes an integer indicative of the number of active spatial enhancement layers.

11. The method of claim 1, wherein the ANL message includes an integer indicative of the number of active SNR enhancement layers.

12. The method of claim 1, wherein the ANL message includes an integer indicative of the number of active temporal layers.

13. A system comprising: a sending endpoint; a router coupled to the sending endpoint; and a receiving endpoint coupled to the router; wherein the router is configured to receive a scalabable bitstream from the sending endpoint and send a subset of the scalable bitstream and at least one ANL message indicating the layers in the subset of the scalable bitstream to the receiving endpoint.

14. The system of claim 13, wherein the router removes at least one layer from the scalable bitstream and sends at least one ANL message indicative of the removed layer.

15. A system comprising:
a sending endpoint or router, and
a receiving endpoint coupled to the sending endpoint or router,
wherein the sending endpoint or router sends:
an indication of a full scalable bitstream,
a subset of the scalable bitstream, and
at least one ANL message indicating the layers in the subset of the scalable bitstream to the receiving endpoint.

16. The system of claim 15, wherein the indication of a full sealable bitstream is a Dependency Parameter Set.

17. The system of claim 15, wherein the indication of a full scalable bitstream is a scalability information SEI message.

18. A non-transistory computer readable medium comprising a set of instructions to direct a processor to perform the methods of one of claims 1-12.
